(19) United States
(12) Patent Application Publication
(10) Pub. No.: US 2010/0017247 A1
(43) Pub. Date: Jan. 21, 2010

(54) System and Method for Re-home Sequencing Optimization

(76) Inventors: Feng Liu, Frisco, TX (US); Dongdong Li, Dallas, TX (US); Will A. Egner, Allen, TX (US); Chen Liao, Frisco, TX (US); Yindong Zheng, Dallas, TX (US); He Liu, Bellevue, WA (US)

Correspondence Address: SLATER & MATSIL, L.L.P., 17950 PRESTON RD, SUITE 1000, DALLAS, TX, 75252-5793, US

(21) Appl. No.: 12/443,956

(22) PCT Filed: Mar. 30, 2007
(86) PCT No.: PCT/US07/08213

§ 371 Date: Apr. 1, 2009

Related U.S. Application Data
(60) Provisional application No. 60/849,139, filed on Oct. 2, 2006.

(51) Int. Cl. G06Q 10/00; G06Q 50/00

(52) U.S. Cl. 705/8

(57) ABSTRACT

A system and method for rehome sequencing optimization of a telecommunications network. In a preferred embodiment, a practicable optimized rehome sequencing plan is determined for a rehome plan in order to migrate the network topology from an initial state to a final state while minimizing the costs incurred during the network state transitions across multiple time periods. Constraints that may be considered include specific market restrictions such as the limit on the number of network elements in a cluster, the limit on the number of clusters in a sequencing step, the limit on the number of sequencing steps, and the immobility limit on the network elements. Constraints also may include cost restrictions incurred during network transitions, such as individual cost limits during each network transition state and an overall cost limit of network transitions from the initial state to the final state.

### RELATED APPLICATION DATA

This application claims the benefit of U.S. Provisional Application No. 60/849,139, filed on Oct. 2, 2006, entitled “System and Method for Network Elements Re-home Sequencing for Wireless Communication Networks,” which application is hereby incorporated herein by reference.

### CROSS-REFERENCE TO RELATED APPLICATIONS

This application relates to the following co-pending and commonly assigned patent applications: Ser. No. 10/585,011, filed Jun. 29, 2006, entitled “System and Method for Analyzing Strategic Network Investments in Wireless Networks;” and Serial No. PCT/US06/30744, filed Aug. 8, 2006, entitled “System and Method for Reduction of Cost of Ownership for Wireless Communication Networks,” which applications are hereby incorporated herein by reference.

### TECHNICAL FIELD

The present invention relates in general to telecommunication networks having a plurality of network elements, and in particular to a system and method for generating a practicable optimized sequencing plan in telecommunication networks.

### BACKGROUND

The wireless telecommunications industry has been experiencing tremendous growth for the past several years, with wireless service providers trying to reduce customer churn by maintaining service quality and smoothly running their networks at a lower cost. To achieve these and other goals, generally a first step in network planning and optimization may be the development of a rehome plan. In a rehome plan, a network planner generally determines how to configure network elements in a geographical area to load balance the network due to traffic growth and migrations, minimize the mobility of the traffic flow to reduce its impact on the network performance, etc. Approaches to configuring network topologies for a network rehome plan are discussed in, for example, U.S. Pat. No. 5,937,042, entitled “Method and System for Rehome Optimization,” and U.S. Pat. No. 6,055,433, entitled “Data Processing System and Method for Balancing a Load in a Communications Network,” which patents are hereby incorporated herein by reference.

Generally, merely having a rehome plan is insufficient from an implementation perspective. The next step for the network planner after determining a rehome plan generally is determining how to implement the rehome plan considering practical implementation constraints and minimization of disruption of network performance. Determining such an optimal rehoming sequence plan, while satisfying practical network constraints, can be difficult and time consuming.

### SUMMARY OF THE INVENTION

These and other problems are generally solved or circumvented, and technical advantages are generally achieved, by preferred embodiments of the present invention which generate a practicable optimized sequencing plan for telecommunication networks.

Embodiments of the present invention provide methods and computer programs for generating a rehome sequencing plan for a telecommunications network, comprising inputting an initial topology of network elements for the telecommunications network, generating an initial rehome sequencing plan for rehoming the telecommunications network from the initial topology to a final topology of network elements, and modifying an order of rehome sequencing steps in the initial rehome sequencing plan to generate an optimized rehome sequencing plan having minimized cost.

Other embodiments of the present invention provide a system for generating an optimized rehome sequencing plan for a telecommunications network, wherein the system may comprise a sequencing plan manager configured to generate rehome sequencing plans for rehoming the telecommunications network from an initial network element topology to a final network element topology, a sequencing plan optimizer configured to search for the optimized rehome sequencing plan for the telecommunications network, a sequencing plan calculator configured to determine costs of the rehome sequencing plans, a persistent storage for storing data about the network element topologies, the network elements, and network mobility information, a network manager configured to retrieve the data from persistent storage and format the data into data structures usable by the sequencing plan manager, the sequencing plan optimizer and the sequencing plan calculator, and a graphical user interface for interacting with a user of the system.

An advantage of an embodiment of the present invention is that it optimizes the sequencing or the order of the transition states of the network topologies rather than merely a snapshot of the network topology.

Another advantage of an embodiment of the present invention is that it optimizes the sequencing or the order of the transition states of the network topologies while satisfying practical network constraints.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a preferred embodiment of the present invention;

FIG. 2 is a block/flow diagram illustrating rehome sequencing plans generated from an initial network topology and a final network topology;

FIG. 3 is a block/flow diagram illustrating detailed rehome sequencing steps in a rehome sequencing plan;

FIG. 4A is a geographical display of the performance of a rehome sequencing plan;

FIG. 4B is a chart display of the performance of a rehome sequencing plan;

FIG. 4C is a report table display of the performance of a rehome sequencing plan;

FIG. 5 is a flow chart of a sequencing plan manager;

FIG. 6 is a flow chart of a sequencing plan calculator;

FIG. 7A is a flow chart of a cluster generation process;

FIG. 7B is a flow chart of a greedy search process used to optimize an existing rehome sequencing plan; and

FIG. 7C is a flow chart of a simulated annealing process used to optimize an existing rehome sequencing plan.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely homogeneous or heterogeneous telecommunications networks. In particular, the present invention will be described with respect to GSM wireless telecommunications networks having a plurality of network elements such as base transceiver stations (BTSs), base station controllers (BSCs), and mobile switching centers (MSCs). The invention also may be applied, however, to other telecommunications networks utilizing telecommunication topology transition optimization or to other systems utilizing optimal reallocation of finite interconnected resources.

In accordance with embodiments of the invention, a method and system may automatically determine practicable optimized rehome sequencing plans. Specifically, given a rehome plan with an initial network topology and a final network topology, these embodiments may optimize the order of rehome sequencing steps in such a way that the overall cost and individual costs of the rehome sequencing steps are minimized while the practical constraints are satisfied. As a general case, in one rehome sequencing step, multiple homogenous or heterogeneous network elements from the same network or different networks, respectively, may be rehomed in a cluster-wise way. As a special case, the network elements may be moved one by one in each rehome sequencing step, where the number of network elements involved in the rehome, i.e., the size of the rehome cluster, is 1. The rehome cluster may be advantageously grouped in such a way that the network elements in the rehome cluster are adjacent to each other in terms of closer geographical distance or less mobility traffic between rehome clusters. Depending on the cluster size, the number of rehome sequencing steps may be different for a given number of network elements in a rehome sequencing plan.

After each rehome sequencing step, the corresponding cost may be calculated and expressed in a unified unit such as the net present value (NPV). Generally, the cost for each rehome sequencing step may be affected by prior rehome sequencing steps and may be a function of the mobility of the traffic and the network element utilization. The cost may be scored higher if there is, for example, load unbalancing or more mobility traffic in the network after a rehome sequencing step. The overall cost of the rehome sequencing plan is a function of the costs of all sequencing steps in the rehome sequencing plan. When the number of sequencing steps in the rehome sequencing plan is large, the overall cost of the rehome sequencing plan may be higher due to the longer time span required, assuming that each sequencing step takes a fixed certain amount of time to complete. When the cost of each individual sequencing step is higher, the overall cost of the rehome sequencing plan is higher as well.

In accordance with another embodiment, a series of method steps, such as a heuristic approach, a greedy search approach, a simulated annealing approach, or a combination thereof, may automatically optimize an existing rehome sequencing plan or generate a new optimal rehome sequencing plan while satisfying practical constraints. If a new practicable optimized rehome sequencing plan is desirable, the methods may start from an initial rehome sequencing plan with random or heuristic permutation of the rehome sequencing steps, and then may optimize this initial rehome sequencing plan by using one of the methods used to optimize an existing rehome sequencing plan.

Taking a simulated annealing method as an example, the method may start from an initial rehome sequencing plan and may search for an alternative sequencing plan with either a higher or lower cost. The alternative sequencing plan with a lower cost may be accepted with a higher probability while the plan with a higher cost may be accepted with a lower probability. The acceptance probability of an alternative rehome sequencing plan with a lower cost gradually may become higher as the progress of the search deepens. Accepting an alternative rehome sequencing plan with a lower cost may be used to search for a globally optimal rehome sequencing plan. Theoretically, the simulated annealing may find the absolute optimal rehome sequencing plan with the lowest cost In reality, the simulated annealing approach, for example, generally may find a practicable optimized rehome sequencing plan with a cost very close to the lowest cost. These embodiments also may allow the network planner to manually adjust an existing rehome sequencing plan by changing the clustering of network elements and the order of the sequencing steps.

In accordance with other embodiments, a method and system generally may display the cost of every individual rehome sequencing step and the overall cost of the rehome sequencing plan with a graphical user interface (GUI). The GUI also may display the network topologies generated before and after every rehome sequencing step and may compare multiple network topologies in a geographical map as well as in a report format. In addition, the GUI may provide a platform for the network planner to manually adjust the clustering of network elements, the grouping of clusters into a rehome sequencing step, and the order of the rehome sequencing steps in a rehome sequencing plan. The GUI also may receive specific method-related parameter inputs from the network planner. At the back end, persistent storage may store the network topologies, costs of network topologies, user operation histories, and miscellaneous system maintenance activities. The persistent storage also may be used to load historical rehome sequencing plans and to recover from system crashes.

Generally, a network planner determines a rehome sequencing plan to migrate the network from an initial network topology (or state) to a target network topology (or state). In conjunction with the embodiments disclosed herein, the final network topology may be derived using systems and methods disclosed in Serial No. PCT/US06/30744, filed Aug. 8, 2006, entitled “System and Method for Reduction of Cost of Ownership for Wireless Communication Networks.” Also in conjunction with the embodiments disclosed herein, analysis, deployment and decommissioning of capital investments in a network topology may be performed using systems and methods disclosed in Ser. No. 10/585,011, filed Jun. 29, 2006, entitled “System and Method for Analyzing Strategic Network Investments in Wireless Networks.”

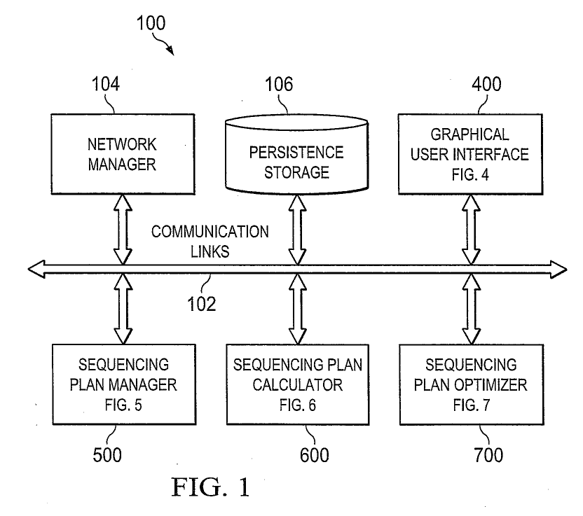

With reference to FIG. 1, there is shown a block diagram of a preferred embodiment computer system 100 for determining a practicable optimized rehoming sequence for a telecommunications network. Rehome sequencing generally refers to an ordered set of network states that are middle steps to migrate the network topology from the initial state to the final state. A particular rehome sequence generally is a selected permutation of the various rehome activities. One rehome activity generally changes the network connectivity of a network element or a cluster of network elements. System 100 may be implemented in software code on one or more computers, which may be PCs, workstations, servers and the like, and which may be commonly located or distributed. System 100 includes graphical user interface (GUI) 400 that interacts with network planners and communicates with other components in system 100 using communication links 102. GUI 400 may be viewed by a network planner on any type of computer display or monitor. Sequencing plan manager 500 generates a list of sequencing plans, while sequencing plan calculator 600 calculates the cost of each individual rehome sequencing step as well as the overall cost of a rehome sequencing plan, and sequencing plan optimizer 700 optimizes an existing sequencing plan.

Network manager 104 may temporarily store the network topologies, network demand, and network element capacities read from persistence storage 106, for example, permanent or non-volatile magnetic, optical or electronic storage in the form of files, database tables, and the like. Communication links 102 connect all the components in computer system 100 and provide message exchanges between them. Communication links 102 may be any combination of inter-module messaging protocols, internal or external computer buses, and wired or wireless network connections such as local area or wide area networks, Ethernet, Internet, and the like. The various elements of system 100 may be implemented in software executed from active system memory such as random access memory by one or more processors.

The network topologies, network elements including their types and capacities, and network mobility in terms of handovers and location updates between network elements may be stored magnetically, optically or electrically in persistent storage 106 in the form of, e.g., files, database tables, and tapes. Persistent storage 106 also may store historical rehome sequencing plans and user operations. Persistent storage 106 also may have standby and data backup systems. A standby system may provide hot standby to minimize failure rate while a data backup system may be used to recover the system from disaster by periodically backing up the system, e.g., on a daily or weekly basis.

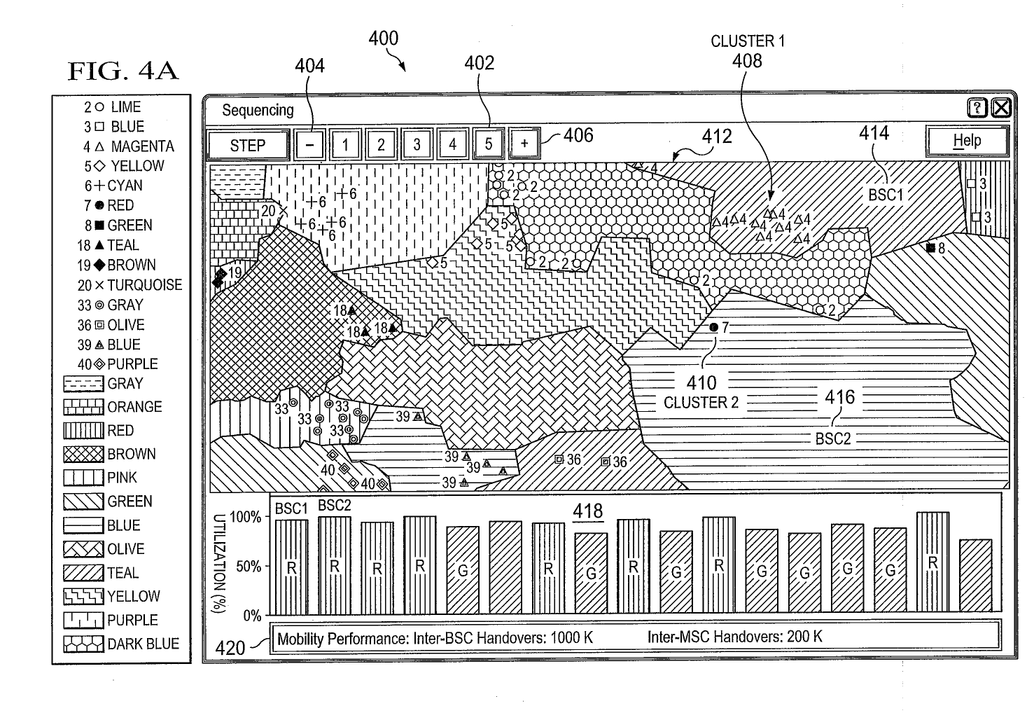

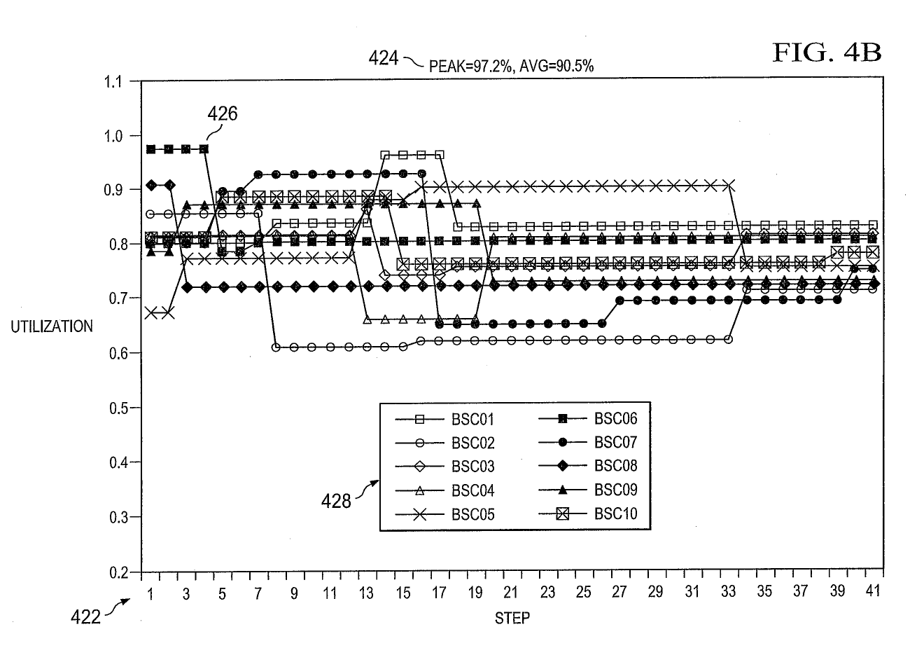

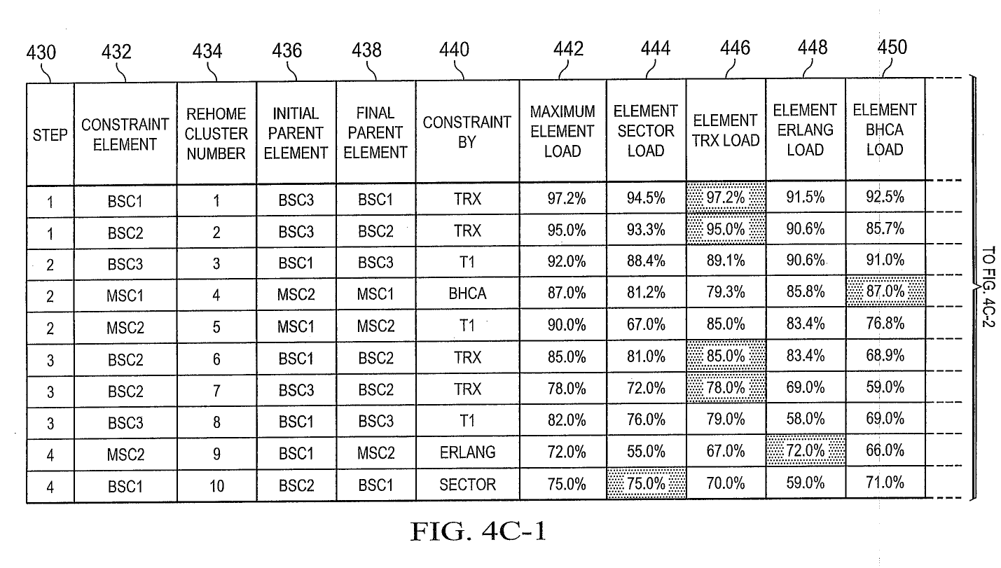

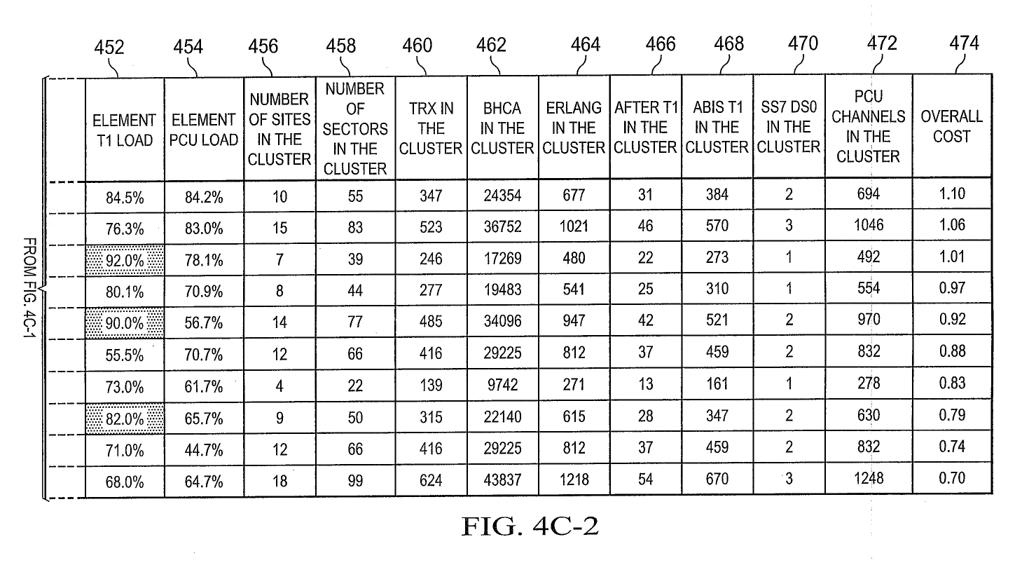

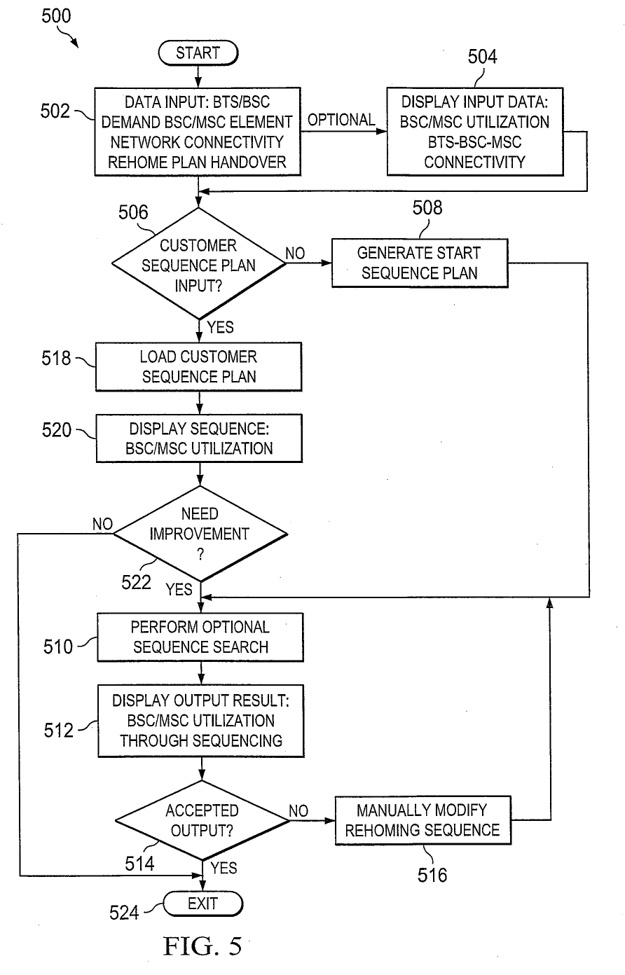

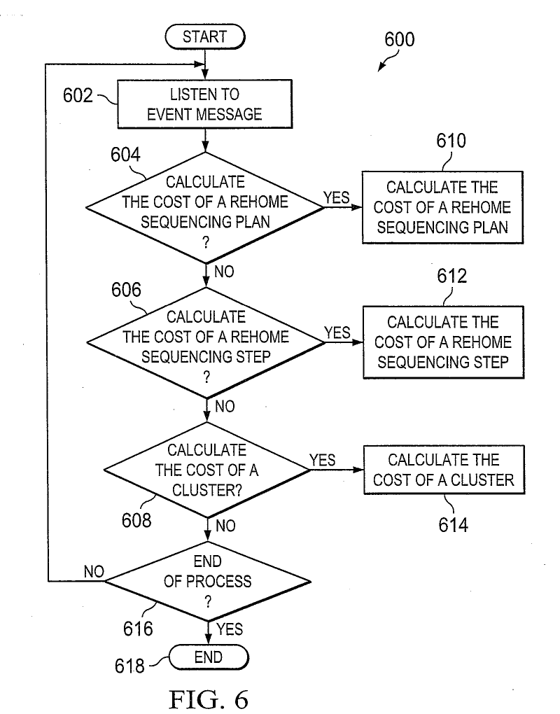

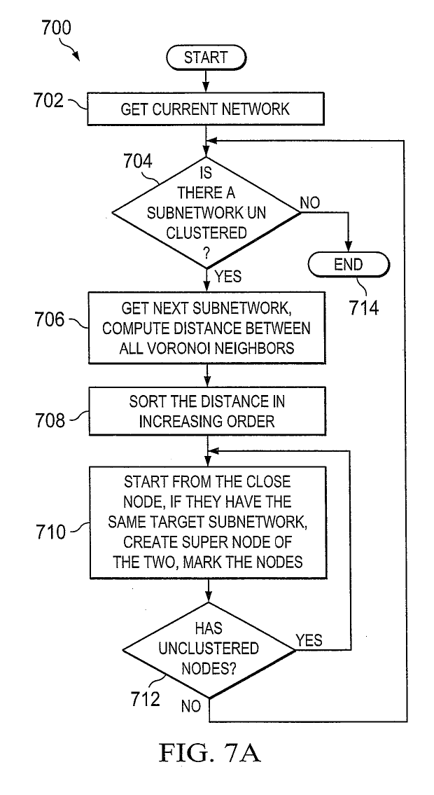

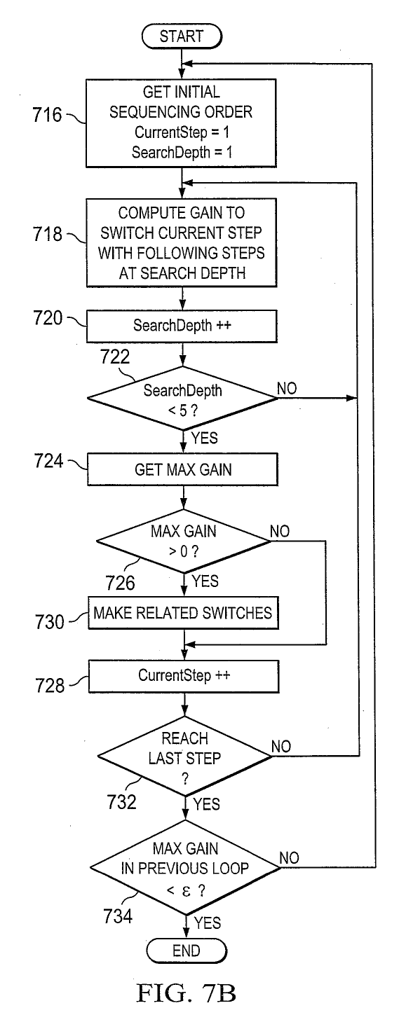

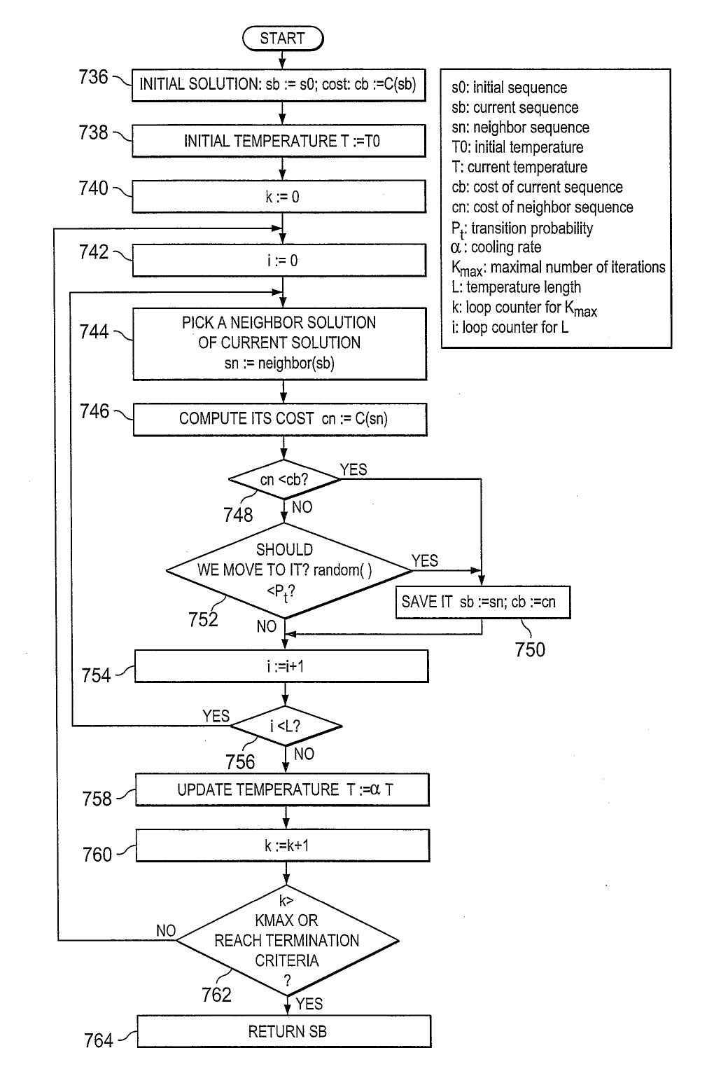

Network manager 104 reads and loads the network elements, network topologies, and network mobility measurements into an internal data structure such as lists or hash tables. Sequencing plan calculator 600, an example of which is illustrated in more detail in FIG. 6, may be called by sequencing plan manager 500, an example of which is illustrated in more detail in FIG. 5, and sequencing plan optimizer 700, an example of which is illustrated in more detail in FIG. 7, to calculate the cost of each rehome sequencing step and the overall cost of the rehome sequencing plan. Sequencing plan optimizer 700 may implement optimization processes such as heuristic search, greedy search, and simulated annealing approaches to search for a rehome sequencing plan with less cost. Sequencing plan manager 500 may receive user inputs from GUI 400 and may determine which corresponding component in system 100 should be called to execute the user commands. GUI 400, an example of which is illustrated in more detail in FIG. 4, may be used to input user inputs and also to display the rehome sequencing steps in a geographical map or in a report format.

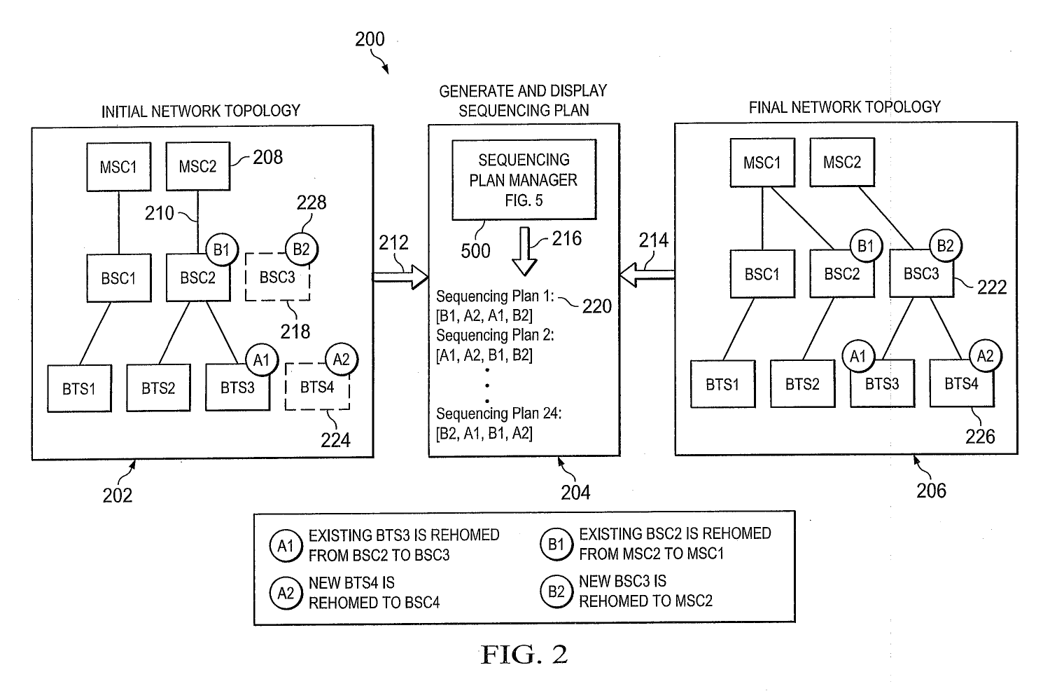

As an example of network rehoming sequence, with reference to FIG. 2, an initial network consists of BTS1-BTS3, BSC1-BSC2, and MSC1-MSC2. A final network consists of BTS1-BTS4, BSC1-BSC3, and MSC1-MSC2. Note that these BTSs, BSCs, and MSCs may be either from a homogenous network (e.g., all from a GSM network or all from a UMTS network) or heterogeneous networks (e.g., part from a GSM network and part from a UMTS network). As used herein, unless otherwise indicated by the context, heterogeneous networks are understood to include homogeneous networks. In this example, the network elements rehome activities from the initial network state to the final network state are:
A1: Existing BTS3 is connected to BSC3 instead of BSC2;
A2: New BTS4 is connected to BSC3;
B1: Existing BSC2 is connected to MSC1 instead of MSC2; and
B2: New BSC3 is connected to MSC2.

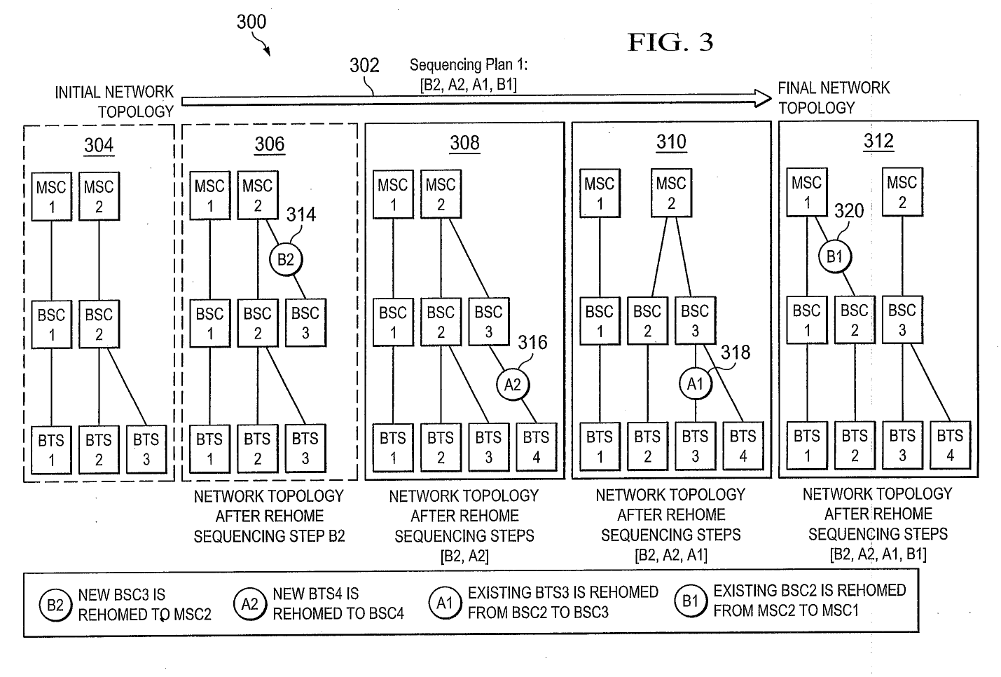

The rehome sequencing from the initial network state to the final network state is a permutation of rehome activities A1, A2, B1, and B2. The number of permutations generally is the factorial of the number of rehome activities, and in this case, for 4 rehome activities is the factorial of 4, i.e., 4!=4×3×2×1=24. Thus, in this example, there are 24 possible sequencing plans for migrating the network from the initial network state to the final network state. One possible sequencing plan is [B2, A2, A1, B1] as shown in FIG. 3, with the rehome activity B2 executed prior to A2, A2 prior to A1, and A1 prior to B1. In order to choose an optimal rehome sequencing plan, generally all these possible sequencing plans should be compared and the one with the least cost should be selected.

The cost of a rehome sequencing plan generally is not a simple summation of all costs incurred in every individual rehome sequencing step, however, because the rehome activities are correlated and a prior rehome sequencing step affects the cost of executing the subsequent rehome sequencing steps. In this example, the cost of executing rehome activity [B2, A2, A1, B1] generally is not equal to the summation of the costs incurred by executing rehome sequencing steps A1, A2, B1, and B2 separately. The overall cost and cost of network state transitions may be calculated using a unified unit, such the net present value (NPV), where the feasibility, implementation costs, network performance, network element utilization during the rehome sequencing plan, and network limits such as capacity limit, etc. are translated into such a unified unit.

One can easily imagine that, given a network transition with a large number of rehome activities, the number of possible rehome sequencing plans can be very large. The simplest but tedious and costly way to find an optimal rehome sequencing plan is to compare the costs of all possible sequencing plans. If the number of rehome activities is N, the number of possible sequencing plans is N factorial, or N!. The costs of all possible sequencing plans should be calculated in an O(N!) time, and a smallest one should be chosen by comparing the costs in an O(N!*log(N!)) time. The total complexity generally is O(N!), which is a Non-deterministic Polynomial-time complete (NP-complete) problem; that is, the problem generally cannot be solved in a polynomial time. Obviously, such a brute-force method generally is not practically feasible. To reduce the computation complexity in finding the absolute optimal sequencing plan, processes running in a polynomial time should be used to generate a practicable optimized rehome sequencing plan. The practicable optimized rehome sequencing plan may not be absolutely optimal, but generally achieves a minimized cost that is close to the absolute minimum cost achieved by the absolute optimal rehome sequencing plan, while at the same time satisfying practical network constraints. In particular, the minimized cost of the practicable optimized rehome sequencing plan may be within 20%, preferably within 10%, or more preferably within 5%, of the global minimum cost of the absolute optimal rehome sequencing plan.

FIG. 2 further illustrates rehome sequencing plan generation as implemented on system 100 of FIG. 1. Initial network topology 202 and final network topology 206 are loaded by sequencing plan manager 500 from persistent storage 106 by calling network manager 104. Then sequencing plan manager 500 calls sequencing plan calculator 600 or sequencing plan optimizer 700 to generate feasible sequencing plans 220. Sequencing plan generation 204 includes sequencing plan manager 500 and generated sequencing plans 220. As stated hereinabove, in this example there are a total of 24 sequencing plans.

Network topologies 202 and 206 may be loaded by loading steps 212 and 214, respectively. The rehome sequencing plan may be displayed 216 to a network planner. An example of a rehome sequencing step 228, that is, the movement of the network connectivity of network elements, is shown in initial network topology 202. The four rehome steps, A1, A2, B1 and B2 are listed at the bottom of FIG. 2. Within network topology 202 or 206, the multiple network elements, such as MSC2 208, BSC3 218 and BTS4 224 are represented as rectangles. The elements are connected by connectivity links, such as connectivity link 210 connecting MSC2 and BSC2. The dotted line border of BSC3 218 and BTS4 224 in initial network topology 202 indicates that these are new network elements. The solid line border of BSC3 222 and BTS4 226 in final network topology 206 indicates that these network elements are part of final topology network 206. In rehome sequencing step B1 228, for example, BSC3 222 is added to the network and connected to MSC2, and in rehome sequencing step A2, BTS4 226 is added to the network and connected to BSC3 222. Similarly, rehome sequencing step B1 denotes that BSC2 is connected to MSC1, instead of MSC2, in the final network topology, and rehome sequencing step A1 denotes that BTS3 is connected to BSC3, instead of BSC2, in the final network topology.

With reference now to FIG. 3, there are depicted detailed rehome sequencing steps in a rehome sequencing plan 300. In FIG. 3, the sequencing plan is taken as [B2, A2, A1, B1] as an example. Initial network topology 304 is evolved to final network topology 312 through sequencing plan 302. In the first rehome sequencing step 314, a new BSC3 is added to the network and connected to MSC2, with the resulting network topology denoted as component 306. From network topology 306, a new BTS4 is added into the network and connected to BSC3 in the second rehome sequencing step 316. From network topology 308, a third network rehome sequencing step 318 is executed by rehoming an existing BTS3 from BSC2 to BSC3. Finally, network topology 310 is evolved to the final network topology 312 by rehoming existing BSC2 from MSC2 to MSC1 in the fourth rehome sequencing step 320. As can be seen in this example, each rehome sequencing step in the sequencing plan [B2, A2, A1, B1] results in a new network topology. In this example, the number of network elements manipulated in each rehome sequencing step is a single one. Embodiments of the present invention also include the movement of network elements in a cluster-wise manner, where network elements are grouped into clusters according to performance indicators such as distance, mobility traffic, and location update events between the elements.

With reference now to FIG. 4A, GUI 400 is depicted displaying a geographical representation of the network topology and its performance gauges during a rehome sequencing plan. On an upper portion of the screen, there are buttons depicting the rehome sequencing steps in an ascending order, from 1 to 5 for this example. The current selected rehome sequencing step is 5, wherein button 402 is highlighted. If the network planner clicks minus button 404, GUI 400 will display one step backward from the current one, which in this example would be rehome sequencing step 4. On the other hand, if the network planner clicks plus button 406, GUI 400 will display one step ahead of the current one, which in this example would be rehome sequencing step 6, if step 6 exists. If the total number of steps is five and step 5 is displayed, pressing button 406 would continue to show the current rehome sequencing step, i.e., step 5.

When the network planner chooses a rehome sequencing step, such as step 5 402, GUI 400 displays the geographical locations of network elements in the current network topology and specifically, the state of the network elements in the rehome sequencing plan before the execution of rehome sequencing step 5. The network elements are grouped in clusters and labeled using the corresponding sequencing number of the rehome sequencing step. For example, cluster 1 408 including, e.g., 9 BTS elements, is located in BSC1 414, which may be color coded using, e.g., a pink color and labeled by its rehome sequencing step 4, which indicates that the BTS network elements of cluster 1 are rehomed to BSC1 414 after rehome sequencing step 4. Note that each single polygon in map 412 may be color coded to represent the geographical serving area of a single BSC, and dots colored with the same color may represent the BTSs that belong to the same rehome cluster. Other BTSs not in the rehome sequencing plan may be set to be indivisible.

Another example is cluster 2 410, which may be color coded in, e.g., brown color and labeled as rehome sequencing step 7. Because the current rehome sequencing step shown is step 5 in this example, cluster 2 410 is located in the serving area of BSC2 416 prior to its rehome step. In the dashboard in the lower portion of GUI 400, utilization chart 418 shows BSC loading prior to the execution of rehome sequencing step 5. BSC utilization may be color coded so that a red color is assigned to a BSC with a higher utilization and a green color to a BSC with a lower utilization to show the level of balancing in an intuitive or qualitative manner.

Performance indictor 420 shows border performance of serving areas for the current rehome sequencing step. The border performance of serving areas is measured by the mobility traffic loading at different network elements. In this example, the handovers between BSCs or MSCs, i.e., inter-BSC handovers or inter-MSC handovers, are used to measure the border performance of serving areas. The mobility impact also may be indicated by using the location updates between BSCs or MSCs. The border performance of serving areas together with the utilization of network elements may be part of the cost function used to optimize the rehome sequencing steps, as described in detail herein below with respect to FIGS. 6 & 7.

With reference now to FIG. 4B, depicted is a graph or chart display of the performance of a rehome sequencing plan, as displayed or output by GUI 400. In this rehome sequencing plan example, there are 41 rehome sequencing steps 422. The utilization of the network elements, e.g., the BSCs, is plotted for every rehome sequencing step 422, thus providing an overview of the rehome sequencing plan. The utilization of network elements at each rehome sequencing step has the same utilization illustrated in chart 418 in FIG. 4A. As an example, the utilization of a particular BSC, e.g., BSC06 428, is shown at about 97.2% utilization before executing the rehome sequencing step 4 426. After rehoming network elements in cluster 4 to another BSC, i.e., after executing the rehome sequencing step 4, the loading of BSC06 is dramatically dropped to below 80%.

The utilization of the rehome sequencing plan may be calculated by taking the maximum utilization across all rehome sequencing steps, which is given as 97.2% in the performance indicator 424 of the rehome sequencing plan. While the BSC utilization is used as an example for the cost function, other cost functions such as MSC utilization, inter-BSC handovers, inter-MSC handovers, inter-BSC location updates, inter-MSC location updates, and the like, also may be used as the performance indicator. Generally, the cost function may be used to show the cost for each rehome sequencing step and for the overall rehome sequencing plan, and is described in more detail herein below with respect to equation (5).

With reference now to FIG. 4C, depicted is a report display of the performance of a rehome sequencing plan, as displayed or output by GUI 400. Column 430 denotes the order of the rehome sequencing steps, wherein multiple clusters 434 may be included in a single rehome sequencing step 430. In this example, rehome cluster numbers 1 and 2 are in rehome sequencing step 1. Rehome cluster number 1 includes 10 sites and rehome cluster number 2 includes 15 sites, as shown in column 456. Therefore there are a total of 25 sites in rehome sequencing step 1. Cluster 1 is rehomed from an initial parent network element BSC3 (column 436) to the final network parent BSC1 (column 438). After rehoming cluster 1, BSC1 in column 432 becomes the network element having the highest load (column 442) with 97.2% utilization in terms of transceiver (TRX) utilization (column 446). Other utilizations, such as 94.5% sector load in column 444, 91.5% Erlang load in column 448, 92.5% busy hour call attempts (BHCA) load in column 450, 84.5% T1 load in column 452, and 84.2% packet control unit (PCU) load in column 454, are not as high as the TRX utilization in column 446. Because the maximum utilization limits the capacity of network elements, BSC1 in column 432 is said to be constrained by the TRX in column 440.

The reports also lists the number of sites in column 456, the number of sectors in column 458, the number of TRX in column 460, the BHCA in column 462, the Erlang in column 464, the Ater T1 in column 466, Abis T1 in column 468, the number of SS7 DS0 in column 470, the number of PCU DS0 channels in column 472, and the overall cost in column 474 for each cluster. Note that the constraint element also may be an MSC as shown in column 432 for cluster 4. Generally, the rehoming of a cluster may result in loading issues at multiple layers of network elements directly or indirectly connected to it.

With reference now to FIG. 5, there is depicted a flow chart of sequencing plan manager 500. Sequencing plan manager 500 may be initiated, for example, when it receives a rehome sequencing calculation or optimization commands from GUI 400. Sequencing plan manager 500 may load the BTS, BSC, and MSC demand in terms of Sector, TRX, Erlang, BHCA, PCU, Ater T1, Abis T1, SS7 DS0, PCU DS0 channels, and the like, in step 502.

Sequencing plan manager 500 also may load the mobility among network elements such as the handovers and location updates, and the network topologies such as BTS to BSC connectivity and BSC to MSC connectivity by using network manager 104. As an optional function in step 504, sequencing plan manager 500 may display the input demand, network connectivity, and utilization of network elements via GUI 400 in a manner similar to the format shown in FIG. 4A 400.

After loading the input data, sequencing plan manager 500 receives input from the network planner through GUI 400 in step 506. If the network planner has an existing network rehome sequencing plan to load, the network manager 104 may be called to load the rehome sequencing plan from persistent storage 106 in step 518 and display the existing rehome sequencing plan in a geographical map or in reports by calling rehome sequencing calculator 600 and using GUI 400 in step 520. If the initial rehome sequencing plan is not satisfactory, the network planner may choose to optimize the existing rehome sequencing plan in step 522. Otherwise, if a sequence plan is not input, a random permutation of the rehome steps or a heuristic approach may be used to generate an initial rehome sequencing plan in step 508. As an example of a heuristic initialization, a network element, e.g., a BSC, with heavier load is given higher priority in the rehoming sequence.

The optimization of an existing rehome plan or a randomly generated initial rehome sequencing plan is conducted by sequencing plan optimizer 700 in step 510. After the optimization, the optimized rehome sequencing plan may be displayed by GUI 400 in step 512. Then the network planner may be asked via GUI 400 for acceptance of the rehome sequencing plan in step 514. If the network planner chooses to accept the rehome sequencing plan, the rehome sequencing optimization process ends at block 524. Otherwise, the network planner may be allowed to use GUI 400 to manually modify the rehoming sequencing plan in step 516, which may include changing the network elements in a cluster, changing the clusters in a rehome sequencing step, changing the rehome sequencing steps in a rehome sequencing plan, and the like. When the rehome sequencing plan is finalized, the rehome sequencing plan may be implemented on the telecommunications network by executing the rehome activities in the order provided by the rehome sequencing plan.

With reference now to FIG. 6, depicted is a flow chart of sequencing plan calculator 600. Sequencing plan calculator 600 may be initiated in step 602 to listen for event messages. Sequencing plan calculator 600 may check message requests from GUII 400 to see if there is a request to calculate the cost of a rehome sequencing plan (step 604), calculate the cost of a rehome sequencing step (step 606), calculate the cost of a rehome sequencing cluster (step 608), or end the rehome sequencing process (step 616). If any of these are requested, then the corresponding modules are invoked. In particular, module 610 calculates the cost of a rehome sequencing plan, module 612 calculates the cost of a rehome sequencing step, and module 614 calculates the cost of a rehome sequencing cluster.

As an example, if sequencing plan calculator 600 is requested to calculate the cost of a rehome sequencing plan, module 610 is called. Module 610 may make one or multiple calls to module 612 to calculate the costs of all rehome sequencing steps within the rehome sequencing plan, and use the costs of these steps to determine the overall cost for the rehome sequencing plan. Likewise, module 612 may make one or multiple calls to module 614 to calculate the costs of all rehome sequencing clusters within a rehome sequencing step and use the costs of these clusters to determine the overall cost for the rehome sequencing step. As a special case, the cluster may include only one network element. In other cases, the cluster may include two, three, four, or more network elements.

The cost function may be implemented with a unified approach with all costs represented in the same units, e.g., the NPV method. The cost function of a rehome sequencing plan generally is a function of the ordered rehome sequencing steps in the plan. As an example, a rehome sequencing plan denoted as P is represented as:

P=[S_{P1}, S_{P2}, . . . , S_{Pn}, . . . , S_{PN}], (1)

where S_{Pn} is the n^{th} rehome sequencing step in the rehome sequencing plan P. The cost function C(P) of the rehome sequencing plan P is represented as:

C(P)=f_{P}(C(S_{P1}),C(S_{P2}), . . . , C(S_{Pn}), . . . , C(S_{PN})), (2)

Where fₚ( ) is a linear or non-linear function and C(S_{Pn}) is the cost function of the n^{th} rehome sequencing step in the rehome sequencing plan P. If fₚ is a linear function, the average of the cost function C(P) in equation (2) can be expressed as:

$${C}_{avg} ( P ) = {avg}_{n = 1 … N} \{ w ( {S}_{Pn} ) \times C ( {S}_{Pn} ) \} , \\ where {avg}_{n = 1 … N} \{ w ( {S}_{Pn} ) C ( {S}_{Pn} ) \} \qquad ( 3 )$$

is the average value taken over all w(S_{Pn})×C(S_{Pn}), 1≦n≦N and where w(S_{Pn}) is the weight function of the n^{th} rehome sequencing step in the rehome sequencing plan P. If f_{P} is a non-linear function, the maximum of the cost function of C(P) in equation (2) can be expressed as:

$${C}_{max} ( P ) = {max}_{n = 1 … N} \{ w ( {S}_{Pn} ) \times C ( {S}_{Pn} ) \} , \\ where {max}_{n = 1 … N} \{ w ( {S}_{Pn} ) C ( {S}_{Pn} ) \} \qquad ( 4 )$$

is the peak value taken over all w(S_{Pn})×C(S_{Pn}), 1≦n≦N.

The cost function C(P) can be expressed as a weighed sum of the maximum and average cost function as:

C(P)=wₘₐₓ(P)Cₘₐₓ(P)+w_{avg}(P)C_{avg}(P), (5)

and wₘₐₓ(P)+w_{avg}(P)=1.

If the NPV method is used, the weight w(S_{Pn}) can be expressed as w(S_{Pn})=(1+r)^{-TPn}, where r is the compounded monthly rate of return, and TPn is the number of months between the month of executing the n^{th} rehome sequencing step and the month of executing the first rehome sequencing step in the rehome sequencing plan P. The daily or yearly rate of return may also be used to calculate the NPV.

C(S_{Pn}) is the cost function of the n^{th} rehome sequencing step in rehome sequencing plan P, which can be expressed as:

C(S_{Pn})=w_{load}C_{load}(S_{Pn})+w_{HO}C_{HO}(S_{Pn}). (6)

where

w_{load}+w_{HO}=1 (7)

In equation (6) above, C_{load}(S_{Pn}) is the capital and operational cost of executing a rehome step S_{Pn}, determined by using the maximum utilization of every network element in terms of Sector, TRX, Erlang, BHCA, PCU, Ater T1, Abis T1, SS7 DS0, and PCU DS0 utilizations. An example of expressing the utilization may be in a format similar to that shown in FIG. 4. C_{HO} (S_{Pn}) is the revenue generated by executing the rehome step S_{Pn} by using the border performance measured in terms of inter-element mobility such as inter-BSC and inter-MSC handovers.

The cost difference between two rehome sequencing plans P and Q is defined as:

ΔC(P−Q)=C₍P)−C(Q). (8)

If ΔC(P−Q)<0, i.e., C(P)<C(Q), the rehome sequencing plan P is better than the rehome sequencing plan Q in terms of less cost. If ΔC(P−Q)≧0, i.e., C(P)≧C(Q), the rehome sequencing plan Q is better than the rehome sequencing plan P in terms of less cost.

Similar to the calculation of the cost function of C(S_{Pn}), the cost function of a cluster is a weighed sum of the maximum utilization of every network element in the cluster after the rehoming of the cluster in terms of Sector, TRX, Erlang, BHCA, PCU, Ater T1, Abis T1, SS7 DS0, and PCU DS0 utilizations and the border performance measured in terms of inter-element mobility such as inter-BSC and inter-MSC handovers.

With reference now to FIG. 7A, depicted is a flow chart of a cluster generation process. Sequencing plan optimizer 700 may be used to cluster network elements to be rehomed and reduce the cost of an initial rehome sequencing plan. Cluster generation may be the first step in rehome sequencing plan optimization. An example of a rule of thumb for clustering is to group adjacent network elements together.

The network planner usually groups adjacent sites with the same target sub-network in one cluster and rehomes them together. A Voronoi triangulate diagram may be selected to generate the neighbor relationship among all rehome sites. Based on the relationship, network nodes may be merged into super nodes. A high level network may be generated, which is composed of the super nodes. Each Voronoi triangle may be broken into three neighbor pairs. To set up the neighbor relationship, a list with unique neighbor pairs may be generated and saved in the network object. A walk through the list may add the specified neighbors. To record the information, each node may need a new neighbor list. The list may be different from the original neighbor list, which is based on the handover inputs and may be used in calculating handovers between sub-networks.

To generate a high level network composed of clusters, the distance between all adjacent site pairs as indicated by the Voronoi neighbor relationship may be calculated. If two nodes belonging to the same sub-network, have the same target sub-network and the closest distance, a super node composed of the two nodes may be created. Super nodes of super nodes may continue to be built, until there is only one super node (or cluster) for every rehome target sub-network. Next, a search is performed on the highest level for an optimal sequencing order. If no satisfactory solution is found at a higher level, the reverse may be performed to unpack the super nodes layer by layer back to the original network to find a solution. If the original network is reached, that generally indicates that only one site maybe rehomed at each step, which generally is very unlikely to happen.

Referring now back to FIG. 7A, the current network topology is loaded in step 702. A group of network elements, such as a BSC, may be treated as a sub-network. Some of the network elements such as BTSs in a sub-network (e.g., the initial BSC), are going to be rehomed to a target sub-network (e.g., a target BSC), while other network elements are going to be rehomed to another target sub-network, with the rest of the network elements left in the original sub-network. If there is a sub-network that is not clustered (step 704), the sub-network is loaded and the Voronoi neighbor elements are constructed for all network elements in the sub-network (step 706) and the distance is sorted in an ascending order (step 708). Then the nearby nodes to be rehomed to a target sub-network are grouped together to create the super node (step 710). After all nodes in a sub-network have been clustered (step 712), the next sub-network is clustered. After clustering all the sub-networks, the clustering process ends (step 714).

With reference now to FIG. 7B, depicted is a flow chart of a greedy search process for optimizing an existing rehome sequencing plan. The greedy search process generally attempts to achieve gain at each rehome move until no more gain can be found. In this embodiment, the greedy search process may accept a negative gain for intermediate moves as long as the final gain is positive. This feature may increase the searching space and may help to jump out from local minima.

The greedy search process first obtains the initial sequence in step 716. Starting from the first rehome sequencing step, the gain is computed and the maximum gain is attempted to be found instep 718. Instep 720, to increase the search space, multiple continuous switches may be made as long as the overall gain is positive. To reduce the computation cost, the search space may be limited by a maximum number of rehome sequencing steps in a search, for example to less than five as shown in step 722. In that case, only a factorial of 5, i.e., 5!=120 rehome sequencing steps need to be searched in a search iteration, which significantly reduces the computation complexity. The maximum gain for these five rehome sequencing steps is found in step 724. If the maximum gain is greater than 0 (step 726), the five rehome sequencing steps are accepted in step 730. Otherwise, step 728 searches again until the search of all five rehome sequencing steps is finished (step 732). If the maximum gain between two searches is less than a small value, e.g. 0.01%, then the search may be stopped and the rehome sequencing plan may be output in step 734. Otherwise, another search is conducted returning back to step 716.

With reference now to FIG. 7C, depicted is a flow chart of a simulated annealing process for optimizing an existing rehome sequencing plan. Simulated annealing is a global optimization process, the initial inspiration for which came from the annealing technique involving heating and controlled cooling of a material to increase the size of its crystals and reduce their defects. Generally, in simulated annealing, some worse sequences are allowed, but the frequency of accepting a worse sequence gradually decreases as the method proceeds, until finally only better sequences are allowed. Therefore, this process generally includes three procedures: (1) accepting a better rehome sequence; (2) accepting a worse sequence with probability, which may help prevent the method from becoming stuck in a local optimum; and (3) gradually decreasing the temperature to reduce the probability of accepting a worse sequence in terms of cooling schedule. The terminology “temperature” is derived from the physical process of annealing by analogy. It is a parameter that controls the probability of accepting a worse sequence. A simulated annealing process generally has a guaranteed convergence to a global optimal solution with probability one as the number of search iterations goes to infnity. For a limited number of iterations, the process converges to a global optimal solution with a probability approaching one.

Referring again to the simulated anneal process flow chart shown in FIG. 7C, the initial sequencing s0 may be generated using a heuristic initialization or a random initialization and may be called the current rehome sequencing sb (step 736). The cost C(sb) of current rehome sequencing plan sb may be calculated by using equation (5) above. The initial temperature T may be set to T0 in step 738. The current search iteration of the SA process k (step 740) has a maximum number Kₘₐₓ. In each iteration, the temperature T is divided into L equal intervals, with the current step 1 representing the i^{th} interval (step 742).

A neighbor rehome sequencing plan sn is generated from current rehome sequencing sb in step 744 for each rehome sequencing step. A neighboring sequence is generated through the modification of the current sequence. One modification mechanism is to randomly exchange the order of two rehome sequencing steps in the sequence. The cost of the neighbor rehome sequencing plan C(sn), determined according to equation (5) in step 746, is compared to the cost of current rehome sequencing plan C(sb) in step 748. A comparison of the two rehome sequencing plans sn and sb in terms of the cost function is defined in equation (8) and given by ΔC=C(sn)−C(sb). If the neighbor rehome sequencing plan sn is better than the current rehome sequencing plan sb, i.e., ΔC<0, the neighbor sequence sn is accepted unconditionally in step 750. Otherwise, the neighbor sequence sn is accepted with probability Pₜ=e^{-ΔC/T} in step 752.

After this the temperature is increased in step 754 until maximum step L is reached (step 756). Then the temperature T is raised by α times in step 758. The process continues to the next iteration of k (step 760) until the maximum number of iteration Kₘₐₓ or other termination criteria are reached (step 762). The other termination criteria may include the scenario when there is no significant increase of the cost function for several iterations. The optimized rehome sequencing is output in step 764. The simulated annealing process also may set the value of a to be less than one in order to cool down the temperature to search.

Although the present invention and its advantages have been described in detail, it should be understood that various changes, substitutions and alterations can be made herein without departing from the spirit and scope of the invention as defined by the appended claims. For example, many of the features and functions discussed above may be implemented in computer program code as software, hardware, or firmware, or a combination thereof. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding. embodiments described herein may be utilized according to the present invention. Accordingly, the appended claims are intended to include within their scope such processes, machines, manufacture, compositions of matter, means, methods, or steps.

What is claimed is:

1. A method of generating a rehome sequencing plan for a telecommunications network the method comprising:
inputting an initial topology of network elements for the telecommunications network;
generating an initial rehome sequencing plan for rehoming the telecommunications network from the initial topology to a final topology of network elements; and
modifying an order of rehome sequencing steps in the initial rehome sequencing plan to generate a practicable optimized rehome sequencing plan having minimized cost.

2. The method of claim 1, wherein the modifying the order of the rehome sequencing steps comprises a simulated annealing process to generate the practicable optimized rehome sequencing plan.

3. The method of claim 1, wherein the modifying the order of the rehome sequencing steps comprises a greedy search process to generate the practicable optimized rehome sequencing plan.

4. The method of claim 1, wherein the modifying the order of the rehome sequencing steps comprises a heuristic search process to generate the practicable optimized rehome sequencing plan.

5. The method of claim 1, wherein the minimized cost comprises minimized overall utilization of the network elements and inter-element mobility traffic.

6. The method of claim 5, wherein the utilization of the network elements comprises a utilization selected from the group consisting of: sector load, transceiver utilization, Erlang load, busy hour call attempts load, packet control unit load, T1 load, DS0 channel utilization, and combinations thereof.

7. The method of claim 5, wherein the inter-element mobility traffic comprises inter-element handovers and inter-element location updates.

8. The method of claim 5, further comprising measuring the minimized cost using net present value as a unified unit of measurement.

9. The method of claim 1, wherein the generating the initial rehome sequencing plan comprises inputting the initial rehome sequencing plan, the method further comprising inputting the final topology.

10. The method of claim 1, wherein the generating the initial rehome sequencing plan comprises using a random permutation or heuristic selection of the rehome sequencing steps to create the initial rehome sequencing plan.

11. The method of claim 1, further comprising, before the modifying the order of the rehome sequencing steps, clustering adjacent network elements into rehome clusters such that the adjacent network elements are grouped into one of the rehome sequencing steps.

12. The method of claim 11, wherein adjacency of the network elements is determined by geographic distance or inter-element mobility traffic.

13. The method of claim 11, wherein there is only one of the network elements in each of the rehome clusters.

14. The method of claim 11, further comprising combining adjacent ones of the rehome clusters into one of the rehome sequencing steps.

15. The method of claim 1, further comprising implementing the practicable optimized rehome sequencing plan on the telecommunications network

16. The method of claim 1, wherein the telecommunications network is a wireless network, and wherein the network elements comprise base transceiver stations, base station controllers, and mobile switching centers.

17. The method of claim 1, wherein the modifying the order of rehome sequencing steps further comprises comparing at least two intermediate rehome sequencing plans by determining a difference in their respective costs, and the generating the practicable optimized rehome sequencing plan further comprises selecting the intermediate rehome sequencing plan with a lowest relative cost.

18. A system for generating a practicable optimized rehome sequencing plan for a telecommunications network, the system comprising:
a sequencing plan manager configured to generate rehome sequencing plans for rehoming the telecommunications network from an initial network element topology to a final network element topology;
a sequencing plan optimizer configured to search for the practicable optimized rehome sequencing plan for the telecommunications network;
a sequencing plan calculator configured to determine costs of the rehome sequencing plans;
a persistent storage for storing data about network element topologies, network elements, and network mobility information;
a network manager configured to retrieve the data from persistent storage and format the data into data structures usable by the sequencing plan manager, the sequencing plan optimizer and the sequencing plan calculator; and
a graphical user interface for interacting with a user of the system.

19. The system of claim 18, wherein the graphical user interface is configured to display the rehome sequencing plan in a series of geographical maps, and wherein the graphical user interface is configured to receive input from the system user to manually re-cluster network elements in a cluster, re-group clusters in rehome sequencing steps, and re-order rehome sequencing steps in the rehome sequencing plan.

20. The system of claim 18, wherein the graphical user interface is configured to display the rehome sequencing plan in a graph or report format showing a cost of network elements and a utilization of network elements for each rehome sequencing step in the rehome sequencing plan.

21. A computer program product for generating a rehome sequencing plan for a telecommunications network, the computer program product comprising:
computer program code for inputting an initial topology of network elements for the telecommunications network;
computer program code for generating an initial rehome sequencing plan for rehoming the telecommunications network from the initial topology to a final topology of network elements; and
computer program code for modifying an order of rehome sequencing steps in the initial rehome sequencing plan to generate a practicable optimized rehome sequencing plan having minimized cost.
